(19) United States
(12) Patent Application Publication
(10) Pub. No.: US 2023/0325715 A1
(43) Pub. Date: Oct. 12, 2023

(54) SYSTEMS AND METHODS FOR SELF-TRAINING A COMMUNICATION DOCUMENT PARSER

(71) Applicant: RELATIVITY ODA LLC, Chicago, IL (US)

(72) Inventors: Jasneet Singh Sabharwal, Vancouver (CA); Somya Anand, Vancouver (CA); Ayushi Dalmia, Vancouver (CA)

(21) Appl. No.: 18/131,820

(22) Filed: Apr. 6, 2023

Related U.S. Application Data
(60) Provisional application No. 63/328,005, filed on Apr. 6, 2022.

(51) Int. Cl. G06N 20/00

(52) U.S. Cl. CPC G06N 20/00

(57) ABSTRACT

Systems, methods, and computer readable media for self-training a parser of electronic communication documents, such as emails, are provided. These techniques may include applying a parser to a batch of electronic communication documents to identify entities included in unstructured text. The outputs of the parser are used to identify entries in a metadata file associated with the electronic communication documents to generate training data for the parser. The parser is then re-trained using the training data and applied to an additional batch of documents. Through this process, the systems, methods, and computer readable media are able to re-train the parser without obtaining manual annotations of electronic communication documents.

### CROSS-REFERENCE TO RELATED APPLICATIONS

This application claims the benefit of U.S. Provisional Application 63/328,005, entitled “SYSTEM AND METHOD FOR SELF-TRAINING A COMMUNICATION DOCUMENT PARSER,” filed on Apr. 6, 2022, the disclosure of which is hereby incorporated herein by reference.

### FIELD OF THE DISCLOSURE

The present disclosure generally relates to training a parser of communication documents and, more specifically, to utilizing document metadata as a truth to train the parser.

### BACKGROUND

In various applications, a need exists to automatically process electronic communication documents. For example, during a discovery process for a litigation, a producing party is required to produce a corpus of documents that meets the discovery conditions. Within this corpus of documents there may be hundreds of thousands, if not millions, of electronic communication documents that need to be assessed for compliance with the discovery request. Given the large number of documents to assess, automated techniques are often applied to reduce the amount of manual review required to comply with discovery requests.

To facilitate automation of the electronic communication document review process, parsers are often used to automatically analyze the electronic communication documents. Accordingly, there is a need to train the parser to be able to reliably and accurately perform the automated analyses. Conventionally, this involves manually annotated a plurality of documents to indicate the various data the parser is configured to detect and using the annotations as an input to a machine learning model to train the parser in accordance therewith. However, this process still involves significant manual review to generate enough annotations to sufficiently train the parser. Thus, to reduce the amount of manual review needed to train the parser, there is a need for systems and method for self-training a communication document parser.

### BRIEF SUMMARY

In one aspect, a computer-implemented method for self-training an electronic communication document parser is provided. The method includes (1) obtaining, by the one or more processors, a batch of electronic communication documents from a corpus of documents; (2) applying, by the one or more processors, a parser to the electronic communication documents included in the batch of electronic communication documents to identify unstructured text indicating one or more entities; (3) identifying, by the one or more processors, metadata in a metadata file associated with the electronic communication documents to annotate the identified unstructured text; (4) based upon the annotations, re-training, by the one or more processors, the parser; and (5) applying, by the one or more processors, the re-trained parser to annotate additional electronic communication documents included in the corpus of documents.

In another aspect, a system for self-training an electronic communication document parser is provided. The system includes (i) one or more processors; (ii) a communication interface communicatively coupled to a document storage system storing a corpus of documents; and (iii) one or more memories storing non-transitory, computer-readable instructions. The instructions, when executed by the one or more processors, cause the system to (1) obtain a batch of electronic communication documents from a corpus of documents; (2) apply a parser to the electronic communication documents included in the batch of electronic communication documents to identify unstructured text indicating one or more entities; (3) identify metadata in a metadata file associated with the electronic communication documents to annotate the identified unstructured text; (4) based upon the annotations, re-train the parser; and (5) apply the re-trained parser to annotate additional electronic communication documents included in the corpus of documents.

In another aspect, a non-transitory computer-readable storage medium storing processor-executable instructions, that when executed cause one or more processors to (1) train a batch of electronic communication documents from a corpus of documents; (2) apply a parser to the electronic communication documents included in the batch of electronic communication documents to identify unstructured text indicating one or more entities; (3) identify metadata in a metadata file associated with the electronic communication documents to annotate the identified unstructured text; (4) based upon the annotations, re-train the parser; and (5) apply the re-trained parser to annotate additional electronic communication documents included in the corpus of documents.

### BRIEF DESCRIPTION OF THE DRAWINGS

FIG. 1 depicts an example computing environment configured to self-train a parser, according to one embodiment.

FIG. 2 depicts a n example model for a parser configured to parse electronic communication documents, according to one embodiment.

FIG. 3 depicts an example computing system in which the techniques described herein may be implemented, according to one embodiment.

FIG. 4 depicts a flow diagram of an example method for self-training an electronic communication document parser, according to one embodiment.

### DETAILED DESCRIPTION

The embodiments described herein relate to, inter alia, the self-training of an electronic communication document parser. The systems and techniques described herein may be used during an eDiscovery process that is part of a litigation. Although the present disclosure generally describes the techniques' application to the eDiscovery and/or litigation context, other applications are also possible. For example, the systems and techniques described herein may be used by a company or other entity to categorize and/or review its own archived electronic documents and/or for other purposes.

As it is generally used herein, “electronic communication document” refers to an electronic document that represents an exchange between one or more individuals. While many of the examples described herein refer to email, it should be appreciated that the techniques described herein are applicable to other types of electronic communication documents. For example, some instant messaging applications may archive a conversation upon its conclusion. The electronic file that represents the instant messaging conversation may be considered an “electronic communication document.” As another example, social media platforms may support their own form of messaging (e.g., a Facebook message, an Instagram direct message, etc.). These messages may also be considered an “electronic communication document.” Furthermore, recent email-like platforms, such as Slack® blend several types of electronic communications into a single conversation. Thus, exported electronic files that underlie these types of email platforms may also be considered “electronic communication documents.”

Generally, an electronic communication document may be viewed as a compilation of segments built upon one another. That is, a conversation may begin with a root communication. The root communication may be viewed as a one-segment electronic communication document. When a conversation participant replies to the root communication, the reply may include the response as well as the root segment. Accordingly, the reply may be considered a two-segment electronic communication document: a root segment and a segment comprising the participant's reply. The conversation may generally continue in this manner so that each new reply adds another segment to the generated electronic communication documents. When the conversation ends, an end communication may include a segment that corresponds to the end communication itself (a “top level segment”) and a segment that corresponds to each reply contained therein. Assuming the conversation did not fork, each electronic communication document includes a segment for each reply that preceded it in the conversation.

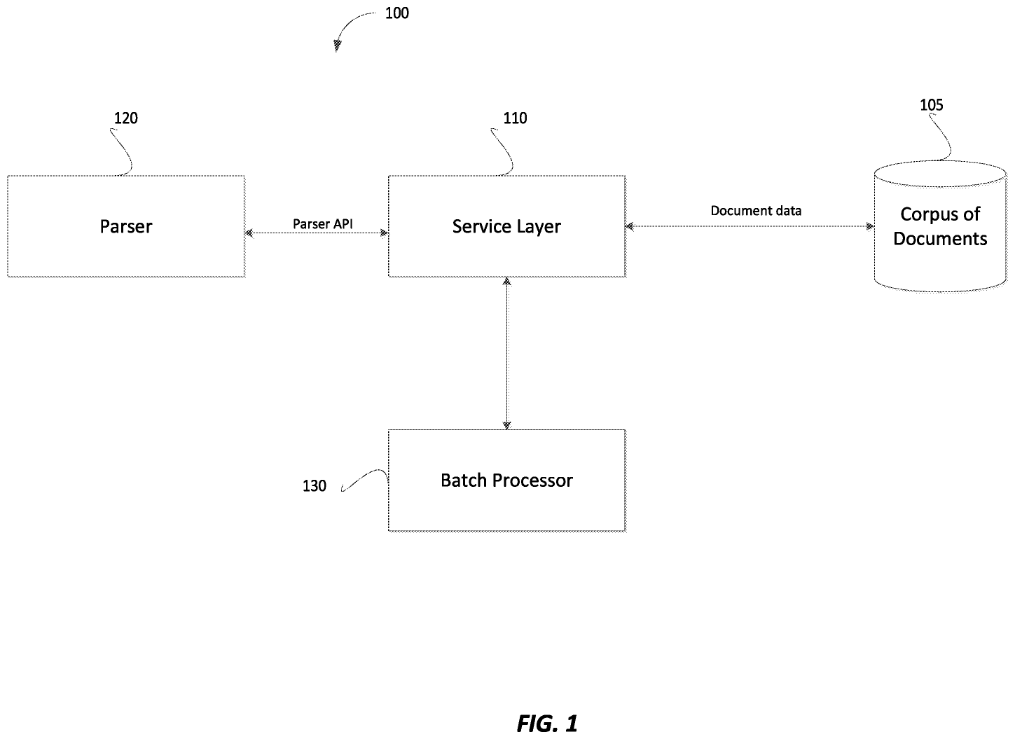

FIG. 1 depicts an example computing environment 100 in which the self-training techniques are applied to a parser 120 that analyzes electronic communication documents within a corpus of documents 105, according to one embodiment. The components of the example computing environment 100 may be implemented as software modules within a cloud and/or distributed computing system (e.g., Amazon Web Services (AWS) or Microsoft Azure). Accordingly, the components of the example computing environment 100 may include separate logical addresses via which the components are accessible via a bus or other messaging channel supported by the cloud computing system. In some embodiments, the example computing environment 100 includes multiple instances of the same component to increase the ability the parallelization for the various functions performed via the respective components.

As illustrated, the example environment 100 includes a service layer 110 configured to, inter alia, interface with documents in the corpus of documents 105 and control usage and/or training of the parser 120 via one or more application programming interfaces (APIs). As one example, the documents within the corpus of documents 105 are maintained at a cloud storage system (not depicted) that interfaces with the service layer 110. Accordingly, the service layer 110 may detect function calls to obtain documents from the corpus of documents 105 and interface with the cloud storage system to load the indicated documents into a working memory. Upon loading the documents into the working memory, the service layer 110 may return an indication of the memory location to the requesting entity. In response to detecting any changes to the documents in the working memory, the service layer 110 may then write the changes to the copy of the document maintained at the cloud storage system.

In some embodiments, the service layer 110 is configured to ingest documents into the corpus of documents 105. As part of the ingestion process, a service layer 110 may be configured to initiate a threading process that reduces the number of electronic communication documents within the corpus of documents 105 by removing electronic communication documents that fail to convey new information. The service layer 110 may then normalize the electronic communication documents that remain after the threading is completed. For example, to reduce the file size of the electronic communication document, the service layer 110 may extract any text from the electronic communication document for storage in an unstructured form.

Most electronic communication document file types also include metadata describing the communications therein. For example, many electronic communication document files include metadata formatted in compliance with a multipurpose internet mail extensions (MIME) standard that specifies the structure (or lack thereof) of the header fields (e.g., a “to” filed, a “from” field, a subject field, a date field, etc.) of the electronic communication documents. Given the flexible nature of the MIME standards, directory protocols have been developed to standardize the references to entities indicated in the MIME header fields across a network (such as the email network of a company subject to a discovery process). For example, lightweight directory access protocol (LDAP), a secure LDAP (LDAPS), and Active Directory (AD) have been developed to create central repositories for the entity information (e.g., name, aliases, email address, title, or other fields that describe the entity). By synchronizing the MIME fields with the corresponding LDAP(S)/AD entry, the service layer 110 is able to create a metadata file indicative of the entities associated with the electronic communication document. For example, the metadata file may be a generic .dat file that includes the LDAP(S) information and an indication of the corresponding electronic communication document that links the two files with one another. The service layer 110 may store the metadata files in the same or different data store as the corpus of documents 105.

As illustrated, the example computing environment 100 includes a batch processor 130 configured to execute automated processing techniques on batches of documents from the corpus of documents 105. Accordingly, the batch processor 130 may be configured to issue commands to a message bus for the service layer 110 to fetch t batch of documents for processing. One such processing technique includes applying the parser 120 to i entities associated with the documents in the batch of documents. Accordingly, the batch processor 130 may issue a command to the service layer 110 to apply the parser 120 to a particular document in the batch of documents. In some embodiments, to issue the command, the batch processor 130 generates a function call in accordance with an API of the parser 120 and writes the call to a bus monitored by the service layer 110 for processing. As part of processing the API call, the parser 120 may output one or more values, such as the identity of one or more entities associated with the document indicated by the API call, and update document information in the working memory in accordance therewith.

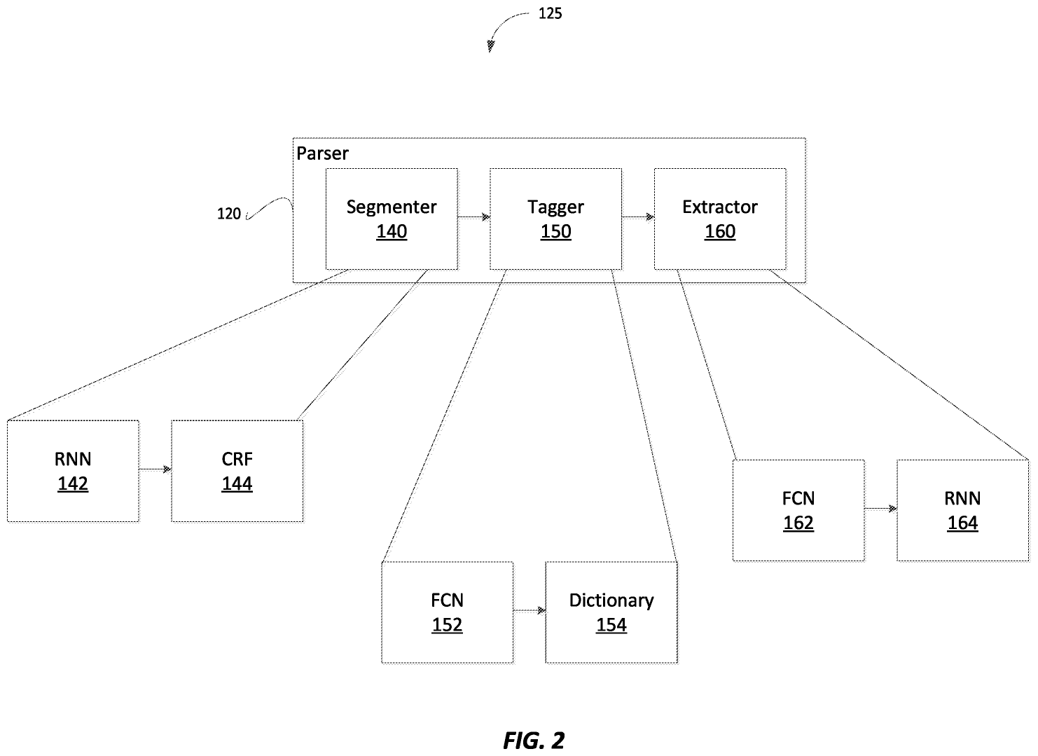

With simultaneous reference to FIG. 2, illustrated is an example model 125 for the parser 120. It should be appreciated that the model 125 is one example model for the parser 120 and alternative models may have additional, fewer, or alternative classifiers that implement alternate machine learning models. For example, while the model 125 may be configured in a manner to process email documents, an alternate model may be more suited for processing other types of documents and/or electronic communication documents. Accordingly, the example computing environment 100 may include multiple parser 120 particularly configured to parse electronic communication documents of different file types.

As illustrated, the parser 120 includes three different classifiers that execute upon a particular document—(1) a segmenter 140 configured to identify segments within an electronic communication document and, for the identified segments, separate metadata indicated in the segment from the body of the segment; (2) a tagger 150 configured to identify particular fields within the metadata identified by the segmenter 140; and (3) an extractor 160 configured to identify entities indicated by particular fields tagged by the tagger 150. Each of the classifiers 140, 150, 160 may be based on one or more machine learning models.

As described above, as part of the ingestion process, the electronic communication document may include text file of the unstructured text extracted from the electronic communication document. Accordingly, the first task in parsing the unstructured text is identifying the different segments of the electronic communication document. The segments are typically identified by processing a sequence of words in the raw text form. As such, the segmenter includes a recurrent neural network (RNN) 142 to identify the potential segmentation points (e.g., the end of the metadata header within a segment or the end of a particular segment) in the unstructured text. In some embodiments, the RNN 142 is implemented using gated recurring units (GRUs) that process entire sequences of the unstructured text. In other embodiments, the RNN 142 implements long short-term memory (LSTM) models (including bi-direction LSTM models) and/or other models compatible with RNNs. After identifying the potential segmentation points, the segmenter 140 may apply a conditional random field (CRF) 144 to label the identified segments as a particular type of segment (e.g., a header indicative of metadata or a body).

After segmenting the unstructured text, the parser 120 may then execute a tagger 150 on the segments identified as corresponding to the header indicative of document metadata. The tagger 150 is configured to parse the metadata segments to identify the boundaries (and thus the values) for particular fields of metadata. For example, the tagger 150 may be configured to detect the boundary between the “To:” field, the “cc:” field, a date, a sender, a subject line, a conversation title, etc. Given that each of these fields have a different structure, the tagger 150 may include machine learning model, such as a fully convolutional network (FCN) 152, that is able to identify the potential borders between fields of different types and lengths. In some embodiments, the FCN 152 applies an n-gram model to segment the text into n-grams of different lengths. The tagger 150 may then include a prefix dictionary 154 to classify the individual portions of the unstructured text as corresponding to particular fields. To this end, the prefix dictionary may include a list of fields associated with an electronic communication document. Each field in the prefix dictionary 154 may include a list of prefixes that indicate the subsequent is likely indicative of a value for that field. For example, an entry in the prefix dictionary 154 for the subject line may include the prefixes of “RE:,” or “FWD:.” Similarly, an entry in the prefix dictionary 154 for the sender field may include the prefix of “From:.” Accordingly, after detecting the beginning boundary of a field, the tagger 150 may analyze the subsequent characters to identify a prefix included in the prefix dictionary 154 for a particular field.

After the tagger 150 identifies particular portions of the unstructured as text as being indicative of particular fields, the parser 120 executes an extractor 160 to identify the boundaries associated with entities included in the particular fields identified by the tagger 150. That is, the extractor 160 may be configured to segment the unstructured text in a given field into its component entities. For example, extractor 160 may execute the FCN 162 on the text included within the “To:” field, the sender field, and/or the “cc:” field. The extractor 160 may then execute an RNN 164, such as a long short term memory (LSTM) model and/or a GRU-CRF model, to identify boundaries between entities included in a given field.

In some embodiments, the machine learning models that underpin the classifiers 140, 150, 160 are pre-trained based on training data from another corpus of documents. For example, a common public corpus of email documents is the Enron Corpus. As another example, a party may have been subject to a prior discovery request as part of an alternate litigation. Thus, the party may have uploaded a different corpus of documents to the computing environment 100. Accordingly, before training the machine learning models based of the parser 120 on the corpus of documents 105, the service layer 110 may first pre-train the machine learning models using the other corpus of documents. Additionally or alternatively, if the computing environment 100 is configured to present documents for manual annotation to train other classifiers, the computing environment 100 may configure the annotation interface to accept annotations related to the classifiers 140, 150, 160. Accordingly, in these embodiments, the service layer 110 may re-train the parser 120 in response to detecting the corresponding manual annotations.

In some embodiments, after the batch processor 130 finishes processing the electronic communication documents included in a batch of documents, the batch processor 130 sends an indication to the service layer 110. In response, the service layer 110 may obtain another batch of documents from the corpus of documents 105 for processing.

As described above, the electronic communication documents analyzed by the parser 120 may correspond to an entry in a metadata file. Accordingly, the metadata file may act as the truth regarding the entities associated with the various fields of the electronic communication document. Thus, the information included in the metadata file may be utilized as training data for the tagger 150 and/or the extractor 160.

Generally, the entries in the metadata file correspond to a top-level segment of an electronic communication document. In one example, the entry for a particular electronic communication document includes indications of an entity in a From: field, one or more entities in a To: field, a date and/or time, a document identifier, and/or other types of metadata. Accordingly, after the segmenter 140 executes on an electronic communication document to segment out the metadata for the top-level segment, the service layer 110 may then analyze the metadata file to identify the entry to the segmented metadata to obtain the ground truth data for training the tagger 150 and/or the extractor 160.

After identifying the corresponding entry, the service layer 110 may then annotate the unstructured text in the metadata of the top-level segment with the entity data included in the metadata file entry. As a result, the annotated text is able to function as training data when training the tagger 150 and/or extractor 160.

In some embodiments, the service layer 110 may be configured to generate training data for the re-training process from each segment included in an electronic communication document. For example, the service layer 110 may identify a corresponding entry in the metadata file based on the respective metadata for each segment of an email communication document. As a result, the service layer 110 may be able to annotate each segment of the electronic communication document based on the data included in the metadata file.

It should be appreciated that if an electronic communication document does not have a corresponding entry in the metadata file for each segment, the electronic communication document may be excluded from the training set. As one simple example, the corpus 105 includes three email chains in the dataset—(1) EC1 containing emails E1, E2, and E3, (2) EC2, containing emails E3 and E1, and (3) EC3 containing emails E4, E5, and E1. In this example, the segmenter 140 will identify the individual segments of the email chains EC1, EC2, and EC3. Because E1, E3, and E4 are the top-level emails of EC1, EC2, and EC3, respectively, the ground truth entity information for E1, E4, and E5 may be included in the metadata file. By using MinHash and locally-sensitive hashing (LSH) Forest techniques, each email chain that includes E1 and E3 can be identified. In this example, this identifies EC1, EC2, and EC3. However, because the metadata file does not include the ground truth entity information for E2 and E5, email chains EC1 and EC3 may be ignored when re-training. That is, only EC2, of which all segments have ground truth entity information in the metadata file, may be utilized in the re-training process for the tagger 150 and/or the extractor 160.

By generating the training data through analysis of the metadata file, the parser 120 can re-trained without additional manual. As a result, the conventional process of obtaining the truth data—users reviewing the document and providing manual annotations—is avoided. This enables the parser 120 to be trained without or with less manual review of electronic communication documents. Additionally, in a conventional training process, the reliance on manual review results in a parser being trained on a small portion of the corpus of documents 105. However, by using the metadata file as the source of truth, the parser 120 can be re-trained even while the parser 120 is being applied to the full corpus of documents 105. As a result, the parser 120 is able to more accurately parse electronic communication documents than conventionally possible.

In some embodiments, the batch processor 130 initiates the re-training process after each electronic communication document in the training set has been annotated with the ground truth data derived from the metadata files. In response, the service layer 110 may initiate a function call to the parser 120 to re-train its machine learning models using the training data derived from the corresponding metadata files. The batch processor 130 may continue to request additional batches of documents until each document in the corpus of documents 105 is processed. Accordingly, the batch processor 130 may apply the parser 120 to each additional batch of documents. The batch processor 130 may cause the parser 120 to be re-trained based upon training data generated for each batch of documents in accordance with the above-described techniques.

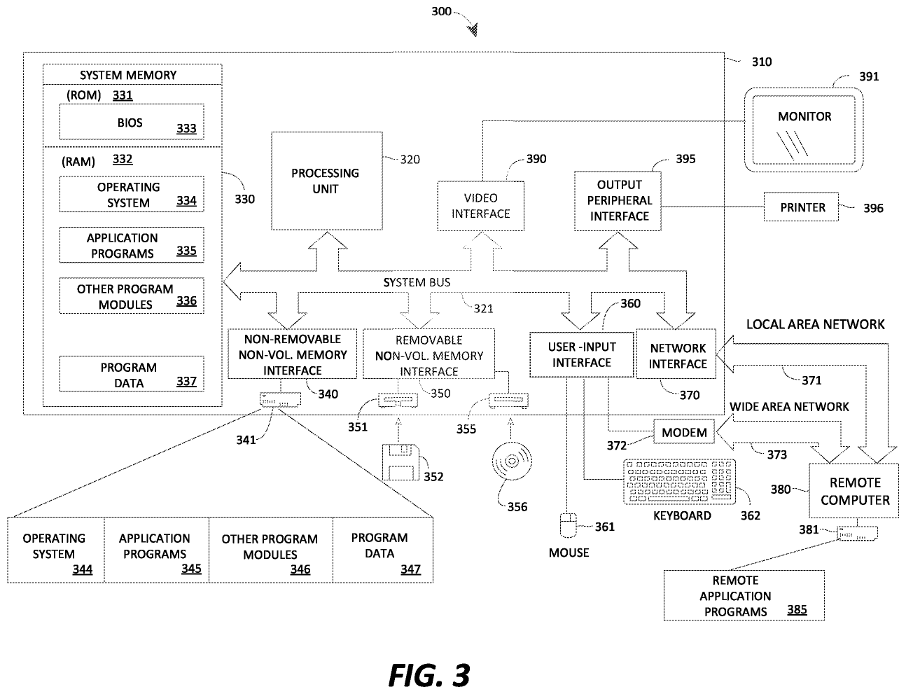

Turning now to FIG. 3, FIG. 3 depicts an example computing system 300 in which the techniques described herein may be implemented, according to an embodiment. For example, the computing system 300 of FIG. 3 may be a computing system configured to implement the service layer 110 of FIG. 1. The computing system 300 may include a computer 310. Components of the computer 310 may include, but are not limited to, a processing unit 320, a system memory 330, and a system bus 321 that couples various system components including the system memory 330 to the processing unit 320. In some embodiments, the processing unit 320 may include one or more parallel processing units capable of processing data in parallel with one another. The system bus 321 may be any of several types of bus structures including a memory bus or memory controller, a peripheral bus, or a local bus, and may use any suitable bus architecture. By way of example, and not limitation, such architectures include the Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 310 may include a variety of computer-readable media. Computer-readable media may be any available media that can be accessed by computer 310 and may include both volatile and nonvolatile media, and both removable and non-removable media. By way of example, and not limitation, computer-readable media may comprise computer storage media and communication media. Computer storage media may include volatile and nonvolatile, removable and non-removable media implemented in any method or technology for storage of information such as computer-readable instructions, data structures, program modules or other data. Computer storage media may include, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 310.

Communication media typically embodies computer-readable instructions, data structures, program modules or other data in a modulated data signal such as a carrier wave or other transport mechanism, and may include any information delivery media. The term “modulated data signal” means a signal that has one or more of its characteristics set or changed in such a manner as to encode information in the signal. By way of example, and not limitation, communication media may include wired media such as a wired network or direct-wired connection, and wireless media such as acoustic, radio frequency (RF), infrared and other wireless media. Combinations of any of the above are also included within the scope of computer-readable media.

The system memory 330 may include computer storage media in the form of volatile and/or nonvolatile memory such as read only memory (ROM) 331 and random access memory (RAM) 332. A basic input/output system 333 (BIOS), containing the basic routines that help to transfer information between elements within computer 310, such as during start-up, is typically stored in ROM 331. RAM 332 typically contains data and/or program modules that are immediately accessible to, and/or presently being operated on, by processing unit 320. By way of example, and not limitation, FIG. 3 illustrates operating system 334, application programs 335, other program modules 336, and program data 337.

The computer 310 may also include other removable/non-removable, volatile/nonvolatile computer storage media. By way of example only, FIG. 3 illustrates a hard disk drive 341 that reads from or writes to non-removable, nonvolatile magnetic media, a magnetic disk drive 351 that reads from or writes to a removable, nonvolatile magnetic disk 352, and an optical disk drive 355 that reads from or writes to a removable, nonvolatile optical disk 356 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 341 may be connected to the system bus 321 through a non-removable memory interface such as interface 340, and magnetic disk drive 351 and optical disk drive 355 may be connected to the system bus 321 by a removable memory interface, such as interface 350.

The drives and their associated computer storage media discussed above and illustrated in FIG. 3 provide storage of computer-readable instructions, data structures, program modules and other data for the computer 310. In FIG. 3, for example, hard disk drive 341 is illustrated as storing operating system 344, application programs 345, other program modules 346, and program data 347. Note that these components can either be the same as or different from operating system 334, application programs 335, other program modules 336, and program data 337. Operating system 344, application programs 345, other program modules 346, and program data 347 are given different numbers here to illustrate that, at a minimum, they are different copies. A user may enter commands and information into the computer 310 through input devices such as cursor control device 361 (e.g., a mouse, trackball, touch pad, etc.) and keyboard 362. A monitor 391 or other type of display device is also connected to the system bus 321 via an interface, such as a video interface 390. In addition to the monitor, computers may also include other peripheral output devices such as printer 396, which may be connected through an output peripheral interface 395.

The computer 310 may operate in a networked environment using logical connections to one or more remote computers, such as a remote computer 380. The remote computer 380 may be a personal computer, a server, a router, a network PC, a peer device or other common network node, and may include many or all of the elements described above relative to the computer 310, although only a memory storage device 381 has been illustrated in FIG. 3. The logical connections depicted in FIG. 3 include a local area network (LAN) 371 and a wide area network (WAN) 373, but may also include other networks. Such networking environments are commonplace in hospitals, offices, enterprise-wide computer networks, intranets and the Internet.

When used in a LAN networking environment, the computer 310 is connected to the LAN 371 through a network interface or adapter 370. When used in a WAN networking environment, the computer 310 may include a modem 372 or other means for establishing communications over the WAN 373, such as the Internet. The modem 372, which may be internal or external, may be connected to the system bus 321 via the input interface 360, or other appropriate mechanism. The communications connections 370, 372, which allow the device to communicate with other devices, are an example of communication media, as discussed above. In a networked environment, program modules depicted relative to the computer 310, or portions thereof, may be stored in the remote memory storage device 381. By way of example, and not limitation, FIG. 3 illustrates remote application programs 385 as residing on memory device 381.

The techniques for self-training a parser of electronic communication documents described above may be implemented in part or in their entirety within a computing system such as the computing system 300 illustrated in FIG. 3. In some embodiments, the computing system 300 is a server computing system communicatively coupled to a local workstation (e.g., a remote computer 380) via which a user interfaces with the computing the computing system 300. For example, the computer 310 may be configured to send predictions to the local workstation for presentation thereat to facilitate a manual review process that validates the performance of the parser 120.

In some embodiments, the computing system 300 may include any number of computers 310 configured in a cloud or distributed computing arrangement. Accordingly, the computing system 300 may include a cloud computing manager system (not depicted) that efficiently distributes the performance of the functions described herein between the computers 310 based on, for example, a resource availability of the respective processing units 320 or system memories 330 of the computers 310. In these embodiments, the documents in the corpus of documents may be stored in a cloud or distributed storage system (not depicted) accessible via the interfaces 371 or 373. Accordingly, the computer 310 may communicate with the cloud storage system to access the documents within the corpus of documents, for example, when obtaining a batch of documents for a batch processor.

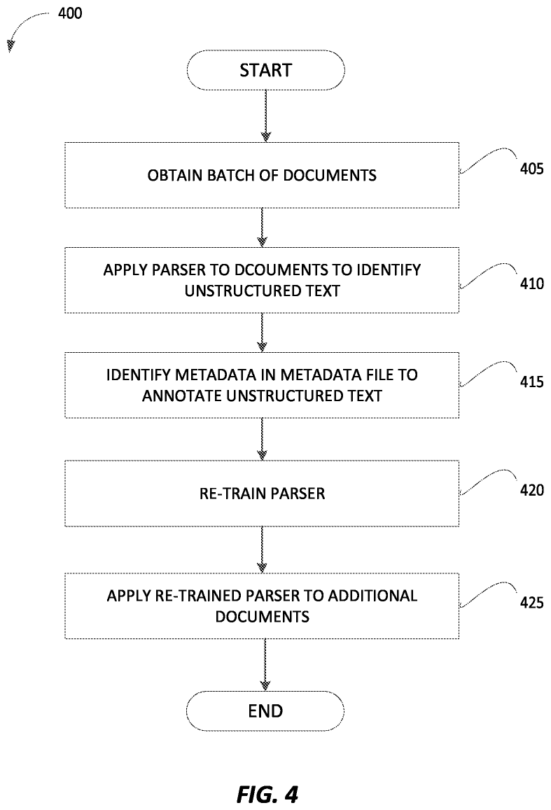

FIG. 4 depicts a flow diagram of an example method 400 for self-training a parser of electronic communication documents, in accordance with the techniques described herein. The method 400 may be implemented by one or more processors of one or more computing devices, such as the computing system 300 of FIG. 3, for example.

The method 400 may begin at block 405 when the computing system obtains a batch of electronic communication documents from a corpus of documents (such as the corpus of documents 105 of FIG. 1). For example, the computing system may be configured to obtain the batch of electronic communication documents in response to receiving a request from a batch processor (such as the batch processor 130 of FIG. 1). To this end, the batch processor 130 may be configured to apply one or more automated processing techniques to documents within the corpus of documents. For example, the batch processor may be configured to apply a parser to electronic communication documents within the corpus of documents to identify any entities associated with the electronic communication document. In view of the memory restraints on the computing system, only a subset of the documents of the corpus of documents may be loaded into the memory at a given time. Thus, the batch processor may issue requests to load batches of parsed documents into the memory for automated processing thereof.

At block 410, the computing system applies parser (such as the parser 120 of FIGS. 1 and 2) to the electronic communication documents included in the batch of electronic communication documents to identify unstructured text indicating one or more entities. In some embodiments, the parser is partially-trained based on electronic communication documents not included in the corpus of documents (such as a publically available corpus of documents) before the parser is applied at block 410. The parser may include (1) a segmenter (such as the segmenter 140 of FIG. 2) configured to segment portions of an electronic communication document that indicates document metadata from portions of the electronic communication document associated with document content; (2) a tagger (such as the tagger 150 of FIG. 2) configured to predict boundaries between fields indicated by the document metadata for the electronic communication document; and/or (3) an extractor configured to identify entities indicated by particular fields identified by the tagger. For example, in some embodiments, the segmenter includes a recurrent neural network (RNN) (such as an RNN that includes gated recurrent units (GRUs)) and conditional random fields (CRF) model, the tagger includes a fully convolutional network (FCN) and a prefix dictionary, and the extractor includes a fully convolutional network (FCN) and an RNN (such as a long short-term memory (LSTM)). It should be appreciated that in other embodiments, the parser may include different classifiers and/or machine learning models that underpin the classifiers depending on the particular needs (such as those driven by the file type for the electronic communication document) and/or performance metrics for which the parser is optimized.

At block 415, the computing system identifies metadata in a metadata file associated with the electronic communication documents to annotate the unstructured text. The computing system may first execute the segmenter to identify the portions of the electronic communication document that indicates the document metadata. For example, the segmenter may divide the electronic communication document into its component segments and then divide the metadata headers from the body of the electronic communication document. Accordingly, the segmenter may identify a top-level segment and at least one lower-level segment included in the electronic communication document. Second, the computing system may identify an entry in the metadata file corresponding to the top-level segment and/or the at least one lower-level segment. Using the identified entries, the computing system may then annotate the unstructured text of the electronic communication documents based upon metadata included in the entry in the metadata file.

At block 420, the computing system re-trains the parser based on the comparison between the outputs of the parser and the metadata associated with the electronic communication documents. For some electronic communication documents, the computing system is able to identify a corresponding entry in the metadata file to annotate the unstructured text for each segment in the electronic communication document. Accordingly, the computing system may re-train the at least one of the tagger and/or the extractor using the annotated unstructured text as training data. For other electronic communication documents, the computing system cannot identify a corresponding entry in the metadata file for at least one segment. Accordingly, in some embodiments, the computing system may exclude these electronic communication documents when training the tagger and/or the extractor.

In some embodiments, the computing system re-trains the parser in response to the batch processor completing the processing of the batch of electronic communication documents. In other embodiments, the computing system re-trains the parser after parser is applied to each electronic communication document in the training set.

As described above, the metadata indicated in the metadata file(s) act as a truth for training the classifiers and/or the machine learning models of the parser. Accordingly, if an output of the parser matches the corresponding annotations, that output may be used to positively reinforce the machine learning model(s). On the other hand, if an output of the parser does not match the corresponding annotations, that output may be used to negatively reinforce the machine learning model(s). It should be appreciated that the particular mechanism for re-training a machine learning model based upon the comparison may vary depending upon the particular machine learning models that form parser. Through this process, the computing system may re-train at least one of the segmenter, the tagger, or the extractor. That is, the computing system may re-train at least one of the RNN or the CRF model of the segmenter, at least one of the FCN or the RNN of the extractor, or the FCN of the tagger. Similarly, the comparison may detect a new prefix not included in the prefix dictionary of the tagger. Accordingly, the computing system may also update the prefix dictionary to include the newly-detected prefix.

At block 425, the computing system then applies the re-trained parser to annotate additional electronic communication documents included in the corpus of documents. For example, the batch processor may request an additional batch of electronic communication documents be loaded into a working memory. Accordingly, the re-trained processor may then be applied to the electronic communication documents in the additional batch of electronic communication documents. As the batch processor requests additional batches of electronic communication documents, the computing system may be configured to apply the actions associated with blocks 410, 415, and 420 to each batch of electronic communication documents. Through this process, the parser is repeatedly re-trained without additional manual annotations resulting in a parser that exhibits better performance metrics (e.g., accuracy, precision, or recall) than a conventional parser training process that relies on manual annotations. That said, in some embodiments, human annotations may still be applied to ensure the accuracy of the self-training techniques. In these embodiments, the number of documents to be manually-annotated may be significantly fewer than if the disclosed self-training techniques were not implemented.

### ADDITIONAL CONSIDERATIONS

The following additional considerations apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” is employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for identifying and grouping likely textual near-duplicates through the principles disclosed herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed:

1. A computer-implemented method for self-training an electronic communication document parser, the method comprising:
obtaining, by the one or more processors, a batch of electronic communication documents from a corpus of documents;
applying, by the one or more processors, a parser to the electronic communication documents included in the batch of electronic communication documents to identify unstructured text indicating one or more entities;
identifying, by the one or more processors, metadata in a metadata file associated with the electronic communication documents to annotate the identified unstructured text;
based upon the annotations, re-training, by the one or more processors, the parser; and
applying, by the one or more processors, the re-trained parser to annotate additional electronic communication documents included in the corpus of documents.

2. The computer-implemented method of claim 1, wherein applying the parser comprises:
applying, by the one or more processors, a partially-trained email parser that was trained based on electronic communication documents not included in the corpus of documents.

3. The computer-implemented method of claim 1, wherein the parser comprises:
a segmenter configured to segment portions of an electronic communication document that indicates document metadata from portions of the electronic communication document associated with document content;
a tagger configured to predict boundaries between fields indicated by the document metadata for the electronic communication document; and
an extractor configured to identify entities indicated by particular fields identified by the tagger.

4. The computer-implemented method of claim 3, wherein re-training the parser comprises:
executing, by the one or more processors, the segmenter to segment the electronic communication document into component communication segments and to identify the portions of the communication segments that indicate the document metadata;
identifying, by the one or more processors, an entry in the metadata file corresponding to a top-level segment of the electronic communication document;
annotating, by the one or more processors, the unstructured text of the electronic communication document based upon metadata included in the entry in the metadata file; and
training, by the one or more processors, the tagger and the extractor based upon the annotated metadata.

5. The computer-implemented method of claim 4, wherein annotating the metadata of the electronic communication document comprises:
identifying, by the one or more processors, a plurality of entries in the metadata file respectively corresponding to electronic communication documents in which the communication segment is a top-level segment; and
annotating, by the one or more processors, the unstructured text of the communication segments using the respective entry in the metadata file.

6. The computer-implemented method of claim 4, wherein training the tagger and the extractor comprises:
comparing, by the one or more processors, the metadata of the communication segments to the metadata file to identify that a communication segment does not correspond to an entry in the metadata file; and
excluding, by the one or more processors, the electronic communication document from a training set used to train the tagger and the extractor.

7. The computer-implemented method of claim 3, further comprising:
re-training, by the one or more processors, at least one of the segmenter, the tagger, or the extractor based upon human-applied annotations.

8. The computer-implemented process of claim 7, wherein:
the segmenter includes a recurrent neural network (RNN) and conditional random fields (CRF) model; and
re-training the segmenter comprises re-training, by the one or more processors, at least one of the RNN or the CRF model.

9. The computer-implemented method of claim 7, wherein:
the tagger includes a fully convolutional network (FCN) and a prefix dictionary; and
re-training the tagger comprises at least one of re-training, by the one or more processors, the FCN or updating, by the one or more processors, the prefix dictionary.

10. The computer-implemented method of claim 7, wherein:
the extractor includes a fully convolutional network (FCN) and a recurrent neural network (RNN); and
re-training the extractor comprises at least one of re-training, by the one or more processors, the FCN or the RNN.

11. A system for self-training an electronic communication document parser, the system comprising:
one or more processors;
a communication interface communicatively coupled to a document storage system storing a corpus of documents; and
one or more memories storing non-transitory, computer-readable instructions that, when executed by the one or more processors, cause the system to:
obtain a batch of electronic communication documents from a corpus of documents;
apply a parser to the electronic communication documents included in the batch of electronic communication documents to identify unstructured text indicating one or more entities;
identify metadata in a metadata file associated with the electronic communication documents to annotate the identified unstructured text;
based upon the annotations, re-train the parser; and
apply the re-trained parser to annotate additional electronic communication documents included in the corpus of documents.

12. The system of claim 11, wherein the parser comprises:
a segmenter configured to segment portions of an electronic communication document that indicates document metadata from portions of the electronic communication document associated with document content;
a tagger configured to predict boundaries between fields indicated by the document metadata for the electronic communication document; and
an extractor configured to identify entities indicated by particular fields identified by the tagger.

13. The system of claim 12, wherein to re-train the parser, the instructions, when executed, cause the system to:
execute the segmenter to segment the electronic communication document into component communication segments and to identify the portions of the communication segments that indicate the document metadata;
identify an entry in the metadata file corresponding to a top-level segment of the electronic communication document;
annotate the unstructured text of the electronic communication document based upon metadata included in the entry in the metadata file; and
train the tagger and the extractor based upon the annotated metadata.

14. The system of claim 13, wherein to annotate the metadata of the electronic communication document, the instructions, when executed, cause the system to:
identify a plurality of entries in the metadata file respectively corresponding to electronic communication documents in which the communication segment is a top-level segment; and
annotate the unstructured text of the communication segments using the respective entry in the metadata file.

15. The system of claim 13, wherein to train the tagger and the extractor, the instructions, when executed, cause the system to:
compare the metadata of the communication segments to the metadata file to identify that a communication segment does not correspond to an entry in the metadata file; and
exclude the electronic communication document from a training set used to train the tagger and the extractor.

16. The system of claim 12, wherein the instructions, when executed, cause the system to:
re-train at least one of the segmenter, the tagger, or the extractor based upon human-applied annotations.

17. The system of claim 16, wherein:
the segmenter includes a recurrent neural network (RNN) and conditional random fields (CRF) model; and
to re-train the parser, the instructions, when executed, cause the system to re-train at least one of the RNN or the CRF model.

18. The system of claim 16, wherein:
the tagger includes a fully convolutional network (FCN) and a prefix dictionary; and
to re-train the parser, the instructions, when executed, cause the system to perform at least one re-training the FCN or updating the prefix dictionary.

19. The system of claim 16, wherein:
the extractor includes a fully convolutional network (FCN) and a recurrent neural network (RNN); and
to re-train the parser, the instructions, when executed, cause the system to re-train at least one of the FCN or the RNN.

20. A non-transitory computer-readable storage medium storing processor-executable instructions, that when executed cause one or more processors to:
obtain a batch of electronic communication documents from a corpus of documents;
apply a parser to the electronic communication documents included in the batch of electronic communication documents to identify unstructured text indicating one or more entities;
identify metadata in a metadata file associated with the electronic communication documents to annotate the identified unstructured text;
based upon the annotations, re-train the parser; and
apply the re-trained parser to annotate additional electronic communication documents included in the corpus of documents.
